(19) United States
(12) Patent Application Publication
(10) Pub. No.: US 2021/0154090 A1
(43) Pub. Date: May 27, 2021

(54) Remote-Controlled Vibrator Apparatus

(71) Applicant: Chris Mathews, Pasadena, CA (US)

(72) Inventor: Chris Mathews, Pasadena, CA (US)

(21) Appl. No.: 16/830,211

(22) Filed: Mar. 25, 2020

Related U.S. Application Data
(60) Provisional application No. 62/941,673, filed on Nov. 27, 2019.

(51) Int. Cl. A61H 19/00; A61H 23/02

(52) U.S. Cl. CPC A61H 19/44; A61H 19/34; A61H 23/02; A61H 2201/1207; A61H 2201/1671; A61H 2201/501; A61H 2230/50; A61H 2230/30; A61H 2201/5064; A61H 2201/5097

(57) ABSTRACT

A remote-controlled vibrator apparatus is provided that stimulate both a vagina and a clitoris (e.g., simultaneously), can be worn for a prolonged period of time, and controlled (e.g., exclusively) by a remote user device. Preferred embodiments of the present invention include a shaft that is connected to a tail via a hinge, where the hinge allows the tail portion to pivot with respect to the shaft. The vibrator apparatus may include a plurality of motors, with a first motor in the shaft for stimulating the vagina and a second motor in the tail for stimulating the clitoris. The remote user device (or app operating thereof) may be used to turn the device on/off, control the device (e.g., its mode, motor frequency, motor intensity, etc.), and receive feedback from the device (e.g., operational data, environmental data, user biometric data, etc.).

### BACKGROUND OF THE INVENTION

### 1. Field of the Invention

The present invention relates to a remote-controlled vibrator apparatus or, more particularly, to an apparatus that is configured to stimulate both the vagina (e.g., via a shaft) and the clitoris (e.g., via a tail), be worn for a prolonged period of time (e.g., during the day while performing other activities, etc.), and controlled (e.g., exclusively) by a remote user device. In one embodiment, the apparatus also includes biometric sensors and is configured to communicate biometric data (or data related thereto) to the remote user device.

### 2. Description of Related Art

For many years, devices for sexually stimulating a user, commonly referred to as vibrators, have been used for a variety of reasons. These devices can be used for pleasure by couples, groups or by individuals seeking sexual stimulation. These devices may also be employed as a sexual aid or a therapy device when a sexual partner is unable to sexually perform or fulfil a partner's sexual need.

Generally, such devices are phallus shaped, and manufactured with a single vibrating mechanism. As such, there is no ability to focus on (e.g., stimulate) more than one area at a time. Further, such devices are intended to be operated and controlled by the user of the device. Because of this, for another individual to operate or control the device, the individual must be present with the user during use of the device.

Thus, there is a need for a new and improved vibrator apparatus that is shaped and designed in such a manner that different portions of the user's anatomy can be individually stimulated at the same time. There is also a need for such a device to be controlled by another regardless of the other's location (e.g., proximate to the user, remote from the user, etc.).

And if the device can be controlled by another from a remote location, then there may also be a need for the device to be “worn” instead of physically “applied” to the user. In other words, a traditional vibrator is intended to be physically moved over, in and out of the user, hence the need for the operator to be physically present during use of the device. However, if the device can be controlled remotely (e.g., on the other side of the world, etc.), then it would be advantageous if the device could be worn, preferably for prolonged periods of time. This would give the operator control over not only how the device is operated (e.g., mode, frequency, intensity, etc.), but when the device is operated. Thus, the device should be comfortable, secure, quiet, and inconspicuous.

It would also be beneficial if the device could provide feedback to the operator. In other words, there are advantageous to a device that could inform the operator (e.g., via an application, software, etc.) whether the device is on, active (e.g., currently being worn, etc.), it's status (e.g., mode, frequency, intensity, etc.), and biometrics of the user or information related thereto (e.g., vital signs, vaginal blood volume (VBV), vaginal pulse amplitude (VPA), etc.). This would allow the operator to not only control the device but receive feedback regarding both the device and the user's response thereto.

### SUMMARY OF THE INVENTION

The present invention provides a remote-controlled vibrator apparatus that is configured to stimulate both a vagina and a clitoris (e.g., simultaneously), be worn for a prolonged period of time, and controlled (e.g., exclusively) by a remote user device. Preferred embodiments of the present invention include a shaft portion that is connected to a tail portion via a hinge portion, the hinge portion allowing the tail portion to pivot with respect to the shaft portion. The vibrator apparatus may also be configured to provide feedback data (e.g., operational data, environmental data, biometric data, etc.) to the remote user device.

In one embodiment, the vibrator apparatus (“device) and the remote user device (“phone”) are configured to communicate using standard cellphone technology, i.e., using a SIM card, at least one cell tower, etc. While a SIM card is generally removable and enables a device to communicate with a plurality of mobile communication devices (e.g., GSM devices, LTE-capable devices, etc.), in one embodiment of the present invention, the SIM card is embedded within the device (preventing it from being removed) and is configured to only communicate with a single phone (or app operating thereon). This will establish a personal, permanent relationship between the device (or user thereof) and the phone/app (or operator thereof).

If an exclusive (one-on-one) relationship is desired, the device (or SIM card) may be configured to communicate with (a) only one phone or (b) only one operator. With respect to “one phone exclusivity,” the phone may communicate directly with the device (e.g., via at least one cell tower). This would allow the operator to use the phone to stimulate the user and to receive feedback regarding said stimulation. The phone could also communicate with a host (e.g., via a wide area network, such as the Internet). This would allow the phone to download an app, updates thereto, and other subscriber information (e.g., usage, renewals, session information, etc.).

With respect to “one operator exclusivity,” the phone and device may communicate with one another via the host (e.g., over the Internet). This would allow the operator to use any network-enabled device (e.g., phone, computer, tablet, etc.) to communicate with the device via the host and still provide a one-on-one, or exclusive relationship between the operator and the user. This can be accomplished by only allowing the device to communicate with (e.g., receive commands from, provide feedback to, etc.) a single account (e.g., single user ID, single account number, etc.). In this embodiment, the host would ensure that only commands provided by the operator are provided to the device and ensure that feedback data received from the device is only provided to the operator, regardless of the device that is being used by the operator (e.g., a phone, PC, laptop, tablet, etc.). This can be accomplished by linking user accounts, device IDs, etc.

In an alternate, hybrid embodiment, the device is configured to communicate with the phone via both the host and at least one other communication protocol (e.g., cell tower, etc.). This would allow, for example, the host to facilitate an initial communication (e.g., ensuring that only the operator is in communication with the device), where subsequent communications are direct communication (e.g., over a 4G network, etc.). In this embodiment, the initial communication could be used to inform the device of the specific phone (or the like) that is being used by the operator (e.g., by providing the device with phone identifying information, such as its number, address, etc.). This would allow direct communications without limiting the operator to a particular device.

In a preferred embodiment of the present invention, the device includes a battery and associated charging circuitry (e.g., wireless, wired), at least one indicator (e.g., LED, etc.) for displaying information to the user (e.g., charge level, on, paired, pairing, an active communication session with a phone, etc.), at least one memory (e.g., RAM, ROM, SIM, etc.) allowing the device to store data (e.g., user ID, account number, sensed (detected, measured, etc.) data, other data establishing an exclusive relationship, etc.), a processor and at least one transceiver (e.g., 3G, 4G, WiFi, Bluetooth, NFC, etc.) and an associated antenna for communicating (either directly or indirectly) with the phone.

The device may also include at least one sensor for sensing (detecting, measuring, etc.) operational, user, and/or environmental data. For example, sensors may be used to determine whether the device is active (i.e., being worn, inserted into the user, etc.). This may be accomplished by sensing light, temperature, or other vital signs. Sensors may also be used to sense environmental conditions (e.g., location, elevation, humidity, temperature, etc.). Perhaps most importantly, sensors can be used to sense biometric data of the user (e.g., vital signs (e.g., temperature, heart rate, blood pressure, etc.), moisture (i.e., indicating arousal), vaginal blood volume (VBV), vaginal pulse amplitude (VPA), vaginal wall pressure (or lack thereof), etc.), all of which can be used to detect arousal and other user conditions (e.g., anxiety, stress, calmness, sleep, activity, etc.).

In one embodiment of the present invention, as discussed above, the device includes a shaft portion, a tail portion, and a hinge portion, allowing the tail portion to rotate with respect to (toward and away from) the shaft portion. This would allow the shaft portion to be place inside the user's vagina, and the tail portion rotated toward the shaft portion, until it comes to rest against the vulva (or clitoris portion thereof).

This design accomplishes several objectives. First, when the device is not in use (e.g., when charging, carried in one's purse, etc.), it can be collapsed into a small form factor, rendering the device more portable, compact, etc. Second, by allowing the tail portion to be rotated away from the shaft portion, beyond its normal angle of use, it is easier to insert the shaft portion into the user's vagina (e.g., similar to inserting a tampon). Third, the tail portion can then be rotated toward the shaft portion until it comes into contact with the vulva (or clitoris portion thereof), thereby securing the device in place. Fourth, by rotating the tail portion so that is comes into contact with the vulva, the tail portion can also be used to stimulate the user's clitoris. This is accomplished by placing a motor in the distal end of the tail portion. A second motor can be placed in the shaft portion to stimulate the vagina. Fifth, the tail portion also serves as a safety measure, preventing the device from straying too far into the vagina, making it impossible for the user to retrieve and posing a serious health risk. Sixth, by affixing the tail portion to the clitoris, the device retains it orientation within the vagina, which is necessary for the placement of motors within the shaft portion (e.g., ensuring that the motors are oriented correctly). Finally, because the tail portion is external to the user, it can be used to house components that are preferably external to the user. This may include, for example, certain sensors (e.g., to measure ambient temperature, location, etc.) and communication circuitry (e.g., the transceiver, it's antenna, etc.).

The device preferably includes two motors, a first one in the shaft portion and a second one in the tail portion. The second one may be located toward the distal end of the tail portion so that it stimulates the clitoris. The first one may also be located toward the distal end of the shaft portion (preferably facing the tail portion) to provide vibration deep within the vagina. In one embodiment, the first motor is larger than the second motor, and both should produce pulsating vibrations that create a pleasurable experience and can culminate into a cascade of sensual and enjoyable feelings and ultimately climax. Each motor may have a plurality (e.g., 3, 5, etc.) of intensity levels/vibration speed and a plurality (e.g., 3, 5, 10, etc.) of different vibration patterns. In embodiments involving a hinge portion, a material used to construct (or house) the tail portion and the shaft portion may also be used to connect the same. For example, medical grade silicon could be used to construct (or cover) the tail portion, the shaft portion, and the hinge portion. A biasing device (e.g., metal, hard plastic, etc.) could be embedded within the hinge portion, biasing the device in a starting position. In an alternate embodiment, the hinge portion includes a pin (or the like) allowing the tail portion to rotate (or pivot) with respect to the shaft portion. In this embodiment, the hinge portion may further include a spring, biasing the device into a starting position.

In either embodiment, to ensure cleanliness, prevent bacteria growth, etc., the tail portion, the shaft portion, and/or the hinge portion may be construed using, or encapsulated in, a soft, smooth, preferably pliable material (e.g., silicon). It should have a supple feel, be body-friendly and odorless. Furthermore, the housing should be such that the device meets IPX8 waterproof standards, thus eliminating any possibility of electrical shock while worn or malfunction after washing/rinsing. The housing material should require minimal care and cleaning that wouldn't involve any sort of antibacterial sanitizing, and a simple water rinse should suffice to make the device safe for reuse.

As discussed above, the device is preferably controlled by a remotely located phone, e.g., via an app that is downloaded from a host or other location on the Internet. The app may allow the phone to communicate directly with the device and/or communicate with the device indirectly (e.g., via the host). By way of example, this communication may involve logging into the app, pairing the phone with the device, controlling the device, and receiving/viewing feedback from the device. For example, the operator may be able to turn the device on and off, control the device (e.g., control the intensity of the vibration, control the mode of operation, control the frequency of operation, etc.). The operator may also receive feedback data from the device (e.g., operational information, environmental information, and biometric data (e.g., the user's vital signs, VBV, VPA, etc.)).

A more complete understanding of the present invention will be afforded to those skilled in the art, as well as a realization of additional advantages and objects thereof, by a consideration of the following detailed description of the preferred embodiment. Reference will be made to the appended sheets of drawings, which will first be described briefly.

### BRIEF DESCRIPTION OF THE DRAWINGS

FIGS. 1 and 2 are examples of environments in which the present invention may operate, where a remote device (e.g., smartphone) is in communication (either directly or via a host) with a vibrating device via a wide area network (e.g., cell towers, Internet, etc.);

FIG. 3 exemplifies components that may be included in the remote device illustrated in FIGS. 1 and 2;

FIG. 4 exemplifies components that may be included in the vibrating device illustrated in FIGS. 1 and 2;

FIG. 5 illustrates a method of establishing a communication between a remote device and a vibrating device (e.g., pairing) in accordance with one embodiment of the present invention;

FIGS. 6A-D illustrate a vibrating device in accordance with one embodiment of the present invention, where a tail portion is configured to be rotated toward and away from a shaft portion of the device;

FIG. 7 shows the vibrating device illustrated in FIGS. 6A-E being worn by (e.g., inserted into) the user;

FIGS. 8A and B illustrate how the tail portion of the device may be attached to the shaft portion in accordance with one embodiment of the present invention;

FIGS. 8C and D illustrate how the tail portion of the device may be attached to the shaft portion in accordance with another embodiment of the present invention and how additional motors can be used to perform alternate (e.g., non-vibrational features);

FIGS. 9A and B illustrates how the tail portion of the device may be attached to the shaft portion in accordance with yet another embodiment of the present invention;

FIGS. 10 and 11 illustrate embodiments of the present invention where the tail and/or shaft portions are further covered (e.g., collectively or individually) by a soft, pliable material (e.g., medical grade silicon, etc.);

FIG. 12 illustrates how a spring can be used to bias the tail portion toward the shaft portion of the device in accordance with one embodiment of the present invention;

FIGS. 13 and 14 provide exemplary methods for securing (or maintaining) the tail portion at a particular angle with respect to the shaft portion of the device;

FIGS. 15A and B provide exemplary methods for adjusting a length of the tail and/or shaft portions of the device;

FIGS. 16-26 provide exemplary screen shots of an application operating on a smartphone used to control the vibrating device, where the application is used to pair with, control, and receive feedback from the device; and

FIGS. 27-30 illustrates a vibrating device in accordance with one embodiment of the present invention (similar, and in most ways identical to, the embodiment illustrated in FIGS. 6A-D), where a tail portion is configured to be rotated toward and away from a shaft portion of the device.

### DETAILED DESCRIPTION OF THE PREFERRED EMBODIMENT

The present invention provides a remote-controlled vibrator apparatus that is configured to stimulate both a vagina and a clitoris (e.g., simultaneously), be worn for a prolonged period of time, and controlled (e.g., exclusively) by a remote user device. In one embodiment, the apparatus is also configured to provide feedback data (e.g., operational data, biometric data, etc.) to the remote user device. In the detailed description that follows, like element numerals are used to describe like elements illustrated in one or more figures.

In a preferred embodiment of the present invention, a vibrating device (i.e., the “device”) is configured to be in communication with, and controlled by a remote device, which is preferably an application (i.e., an “app”) operating on a smartphone (i.e., a “phone”), via a wide area network (e.g., cell towers, the Internet, etc.). It should be appreciated that while this is the preferred embodiment, other embodiments are within the spirit and scope of the present invention. For example, a dedicated device other than a phone may be used to control the device (e.g., a computer, a tablet, a remote control, etc.). Similarly, the phone (or the like) and the device may be configured to communicate with one another via a different (e.g., local) communication protocol, such as Bluetooth, Near Field Communication (“NFC”), etc., requiring the operator to be in close proximity to the device.

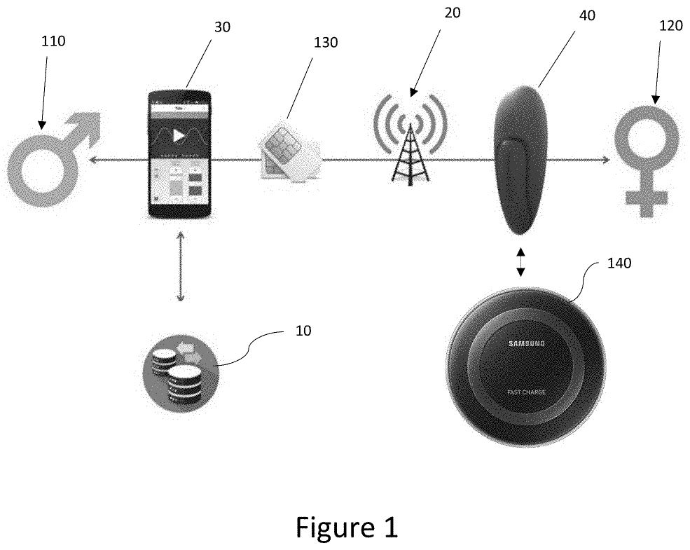

In one embodiment, the device and phone are configured to communicate using standard cellphone technology, i.e., using a SIM card, at least one cell tower, etc. This can be seen in FIG. 1, where a phone 30 is in communication with a device 40 via at least one cell tower 20, where both the phone 30 and the device 40 include a Subscriber Identification Module (“SIM”) 130.

A SIM is an integrated circuit that is intended to securely store the International Mobile Subscriber Identity (“IMSI”) number and its related key, which are used to identify and authenticate subscribers on mobile telephone devices. SIM cards typically contain a unique serial number (ICCID), an IMSI number, security authentication and ciphering information, temporary information related to the local network, a list of the services the user has access to, and two passwords, i.e., a Personal Identification Number (“PIN”) for ordinary use, and a Personal Unblocking Code (“PUC”) for PIN unlocking.

While a SIM card is generally removable and enables a device to communicate with a plurality of mobile communication devices (e.g., GSM devices, LTE-capable devices, etc.), in one embodiment of the present invention, the SIM card is embedded within the device (preventing it from being removed) and is configured to only communicate with a single phone (or app operating thereon) (e.g., by limiting the services and/or devices that it can communicate with). This will establish a personal, permanent relationship between the device (or user thereof) and the phone/app (or operator thereof). Details concerning pairing and the like will be discussed below. With that being said, it should be appreciated that the foregoing is merely preferred, and other embodiments are within the spirit and scope of the present invention. For example, a device that communicates without needing a SIM (e.g., one that communicates via Bluetooth, NFC, WiFi, etc.) is within the spirit and scope of the present invention. So too is a device (or SIM card) that is configured to communicate with a plurality of mobile communication devices.

It should also be appreciated that if an exclusive (one-on-one) relationship is desired, the device (or SIM card) may be configured to communicate with (a) only one phone or (b) only one operator. This “one-on-one relationship” serves multiple purposes. First and foremost, it establishes exclusivity—it is given from one partner to another and can only be activated at the partner's request. In case of a falling-out, in a preferred embodiment, it cannot be paired to a different phone as the original bond is permanent and unalterable. Secondly, this gives the partner total control over the other.

With respect to “one phone exclusivity,” the phone 30 may communicate directly with the device 40 (e.g., via at least one cell tower 20). This would allow the operator 110 to stimulate the user 120 and to receive feedback regarding said stimulation. The phone could also communicate with a host 10 (e.g., via a wide area network, such as the Internet). This would allow the phone to download an app, updates thereto, and other subscriber information (e.g., usage, renewals, session information, etc.).

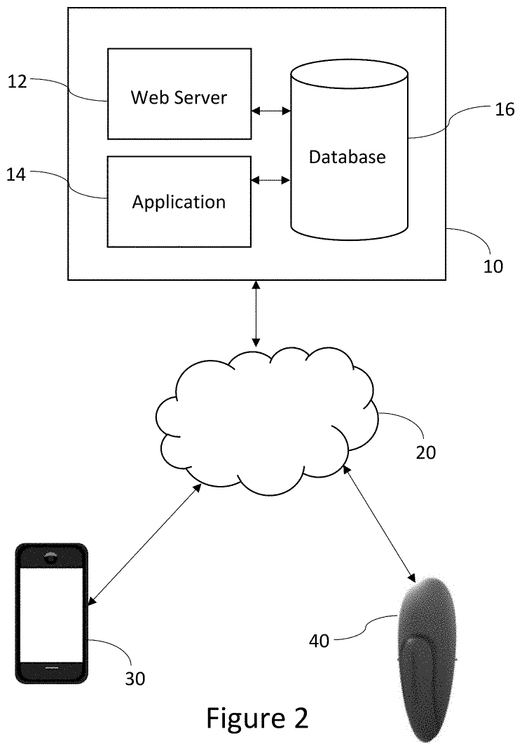

With respect to “one operator exclusivity,” the phone 30 and device 40 may communicate with one another via the host 10. This can be seen in FIG. 2, where both the phone 30 and the device 40 are in communication with the host 10 via a wide area network, such as the Internet 20. This would allow the operator to use any network-enabled device (e.g., phone, computer, tablet, etc.) to communicate with the device 40 via the host 10 and still provide a one-on-one, or exclusive relationship between the operator and the user. This can be accomplished by only allowing the device 40 to communicate with (e.g., receive commands from, provide feedback to, etc.) a single account (e.g., single user ID, single account number, etc.). In this embodiment, the host 10 would ensure that only commands provided by the operator are provided to the device and ensure that feedback data received from the device is only provided to the operator, regardless of the device that is being used by the operator (e.g., a phone, PC, laptop, tablet, etc. This can be accomplished by linking user accounts, device IDs, etc.

It should be appreciated that the invention is not limited to FIGS. 1 and 2. For example, a hybrid is within the spirit and scope of the present invention, where the device 40 is configured to communicate with the phone 30 via both the host 10 and at least one other communication protocol (e.g., cell tower, etc.). This would allow, for example, the host 10 to facilitate an initial communication (e.g., ensuring that only the operator is in communication with the device 40), where subsequent communications are direct communication (e.g., over a 4G network, etc.). In this embodiment, the initial communication could be used to inform the device 40 of the specific phone 30 (or the like) that is being used by the operator (e.g., by providing the device 40 with phone identifying information, such as its number, address, etc.). This would allow direct communications without limiting the operator to a particular device.

Regardless of the embodiment, as shown in FIG. 2, the host 10 may include a database 16 (or memory device) configured to store information concerning the operator, his phone (or other network-enabled device(s)), the user, and/or the device. The database 16 may also be configured to store information concerning sessions between the operator and the user, including how the device was controlled and feedback received as a result thereof. The host 10 may also include an application 14 and a web server 12 configured to communicate with both the phone 30 and device 40. The application 14 could be configured to provide an app or updates to the phone 30 and/or device 40, receive commands from the phone 30, provide commands to the device 40, receive feedback from the device 40, and provide feedback to the phone 30.

It should be appreciated that the feedback provided to the phone 30 may be the actual feedback from the device 40 or information generated as a result thereof. By way of example only, if the feedback data shows that the user's temperature went from 98.6 to 98.7, the feedback data provided to the operator may be the raw data or may merely indicate that the user's temperature has increased. By way of another example, while the application 14 may receive raw data concerning the user's vaginal blood volume (VBV) and/or vaginal pulse amplitude (VPA), the feedback data provided to the operator may merely indicate whether the user is getting aroused (e.g., on a scale of 1-10, low, medium, high, etc.). Not only would this provide a user-friendly graphical user interface (GUI), but it also uses the application 14 to interpret information received from the device. For example, while changes in VBV occur in response to both sexual and anxiety-inducing stimuli, changes in VPA occur only in response to sexual stimuli. Thus, the application 14 should be able to conclude whether the user is merely anxious or sexually aroused and provide that conclusion (or result) to the operator.

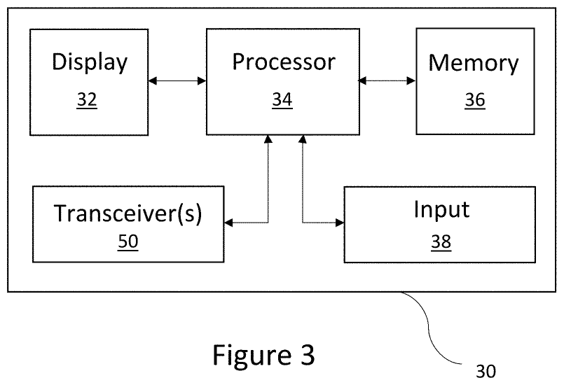

As shown in FIG. 3, the phone 30 (or the like) should include an input 38 (e.g., keyboard, touchscreen, etc.) allowing the operator to input data (e.g., commands, etc.), a display 32 (e.g., LCD, etc.) allowing the operator to view data (e.g., feedback data, etc.), at least one memory 36 (e.g., RAM, ROM, SIM, etc.) allowing the phone to store data (e.g., user ID, password, account number, operational code, etc.), a processor 34, and at least one transceiver 50 (e.g., 3G, 4G, WiFi, Bluetooth, NFC, etc.) for communicating (either directly or indirectly) with the device 40.

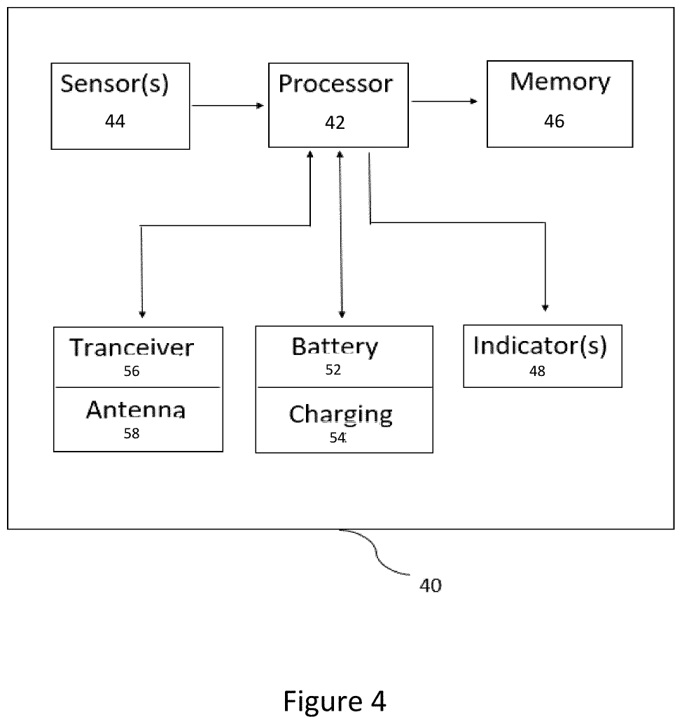

Similarly, as shown in FIG. 4, the device 40 should include a battery 52 and associated charging circuitry 54 (e.g., wireless, wired), at least one indicator 48 (e.g., LED, etc.) for displaying information to the user (e.g., charge level, on, paired, pairing, an active communication session with a phone, etc.), at least one memory 46 (e.g., RAM, ROM, SIM, etc.) allowing the device to store data (e.g., user ID, account number, sensed (detected, measured, etc.) data, other data establishing an exclusive relationship, etc.), a processor 42 and at least one transceiver 56 (e.g., 3G, 4G, WiFi, Bluetooth, NFC, etc.) and an associated antenna 58 for communicating (either directly or indirectly) with the phone 30.

With respect to the battery 52, there are advantages to using a Li-Ion (or equivalent) battery. Due to the sensitive placement of device when worn, the encased battery should conform to all industry standards of safety and precaution. It is of the utmost importance that the device is 100% safe to use, as one single incident could render the product's reputation tarnished beyond repair. As for battery life, the design should provide for two to three hours of continuous use, which is considered the industry standard for sex toys and wearables. There is a specific requirement for this device though, and that is that its standby battery life should be significantly longer than that of similar devices. Ideally, the device should boast at least 24 hours of standby time. It is expected that the device will be worn for prolonged periods of time, typically inserted in the morning at the start of the day and taken out before going to sleep. Thus, the design should preferably get at least two full day wearing sessions with a single charge.

The device may contain a battery level indicator 48 (e.g., consisting of a plurality of LED lights glowing in hot pink color, where all four lit indicate a full charge, and one lit indicates a low charge). When the device is worn, the indicator may be switched off, and may only display its battery level when ejected (e.g., using biometric sensors to detect insertion and removal). Alternatively, the indicator may be turned on in response to an interaction (e.g., when a surface area of the indictor is taped twice).

In a preferred embodiment of the present invention, the device should not house an external charging port and is to only be charged wirelessly (see, e.g., FIG. 1 at 140). The device should have a smooth supple and seamless look about it and having a charging port would require a cap that would affect its smooth silky flow. Furthermore, it could potentially pose a safety concern when worn and that is, when possible, always to be avoided. The device should house state-of-the-art wireless charging similar to that of flagship smartphones of prominent manufacturers. The package should include a wireless charging pad that would aim to fully charge the device in what is considered industry-standard charging time. It should be appreciated, however, that the present invention is not limited to a device that can only be charged wirelessly, and other charging methods (e.g., using a charging port, removable batteries, etc.), understanding that certain safety precautions will have to be taken into account, are within the spirit and scope of the present invention.

The device 40 may also include at least one sensor for sensing (detecting, measuring, etc.) operational, user, and/or environmental data. For example, sensors may be used to determine whether the device is active (i.e., being worn, inserted into the user, etc.). This may be accomplished by sensing light, temperature, or other vital signs. Sensors may also be used to sense environmental conditions (e.g., location, elevation, humidity, temperature, etc.). Perhaps most importantly, sensors can be used to sense biometric data of the user (e.g., vital signs (e.g., temperature, heart rate, blood pressure, etc.), moisture (i.e., indicating arousal), vaginal blood volume (VBV), vaginal pulse amplitude (VPA), vaginal wall pressure (or lack thereof), etc.), all of which can be used to detect arousal and other user conditions (e.g., anxiety, stress, calmness, sleep, activity, etc.).

It should be appreciated that while certain sensors have been identified herein to sense, detect, or measure certain characteristics of the user, the present invention is not so limited. Thus, all biometric sensors that are generally known to those skilled in the art, including, but not limited to those associated with vital signs and sexual arousal (e.g., temperature sensor, pressure sensor, pulse sensor, blood pressure sensor, vaginal photometer, optical sensor, moisture sensor, etc.). It should also be appreciated that the host 10, phone 30, and device 40 may include additional, fewer, and/or different components than those illustrated in FIGS. 2-4. For example, a device 40 that further includes an application (not shown) for communicating with the host 10 and/or phone 30 is within the spirit and scope of the present invention. Similarly, a phone 40 that further includes an application (not shown) for communicating with the host 10 and/or device 40 is also within the spirit and scope of the present invention. The device may also include a means (e.g., button, etc.) for resetting the device, in cases where the pair phone has been lost, etc.

When dealing with an exclusive connection between a device 40 and a phone 30, the system follows the master/slave model, i.e., the phone 30 is the master and can therefore send and receive data to and from any device, including the user's device 40, whereas the user's device 40 is the slave and can only send and receive data to and from the phone 30.

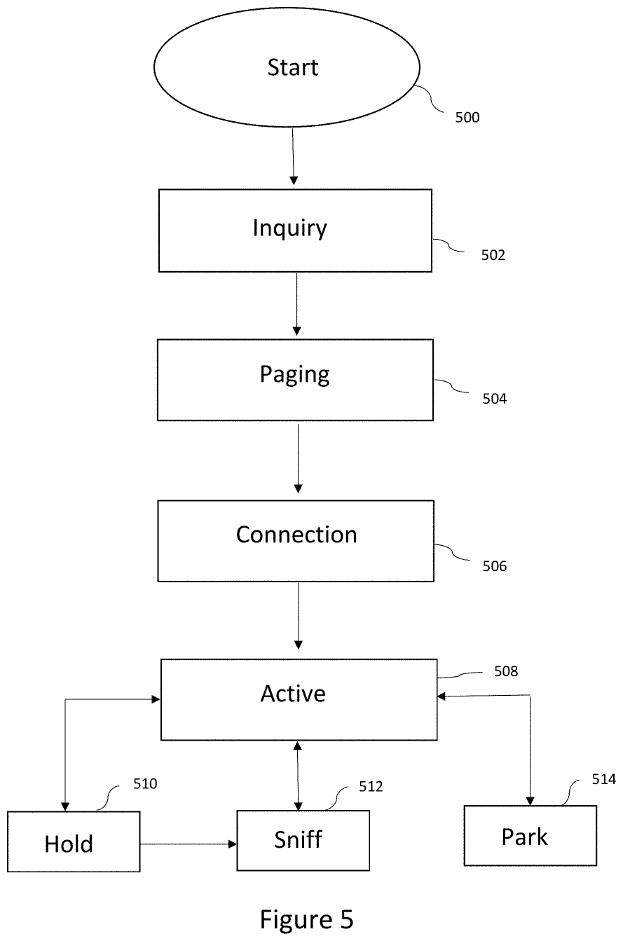

As shown in FIG. 5, the device can generally exist in one of three states: inquiry; paging; and connection. The inquiry state 502 involves the device (or the phone) sending out a request. The request can be responded to with identifying information (e.g., address, name, etc.). The paging state 504 is where the device is aware of the phone (or vice versa) (e.g., after a request is responded to) and attempts to establish a connection. Once a connection is established (i.e., the connection state 506), the device can remain in one of four modes. The first mode is an active mode 508, where the device is actively transmitting and receiving data to and from the phone. The second mode is a sniff mode 512, where the device goes to sleep and only listens for transmissions at set intervals. If a transmission is received, the device goes back into the active mode 508. The third mode is a hold mode, where the device sleeps for a defined period and then returns to either the sniff mode 512 or the active mode 508. The fourth mode is a park mode 514, where the device goes to sleep until woken up (e.g., by the master). A slave may enter into these modes autonomously (e.g., after a predefined period of time of inactivity, etc.) or be placed into a particular mode by the master, depending on how the device is programmed.

It should be appreciated that the present invention is not limited to the method provided in FIG. 5, and methods having fewer, additional, and/or different steps, states, or modes, are within the spirit and scope of the present invention. For example, when dealing with an exclusive connection between a device 40 and an operator, the connection is between the device and the host, where the host acts as the gatekeeper, only allowing communication to and from the operator. In one embodiment, the host may act as an intermediary between the device and the phone, facilitating the inquiry 503, paging 504, and/or the connection 506 steps. In an alternate embodiment, the host may only facilitate the inquiry 503 step, providing identifying information (e.g., address, name, number, etc.) of the phone (or the like) to the device, allowing the device to page the phone (or acknowledge a page from the phone) to establish a connection. This would allow the operator to communicate using different devices (e.g., different phones, a tablet, a computer, etc.).

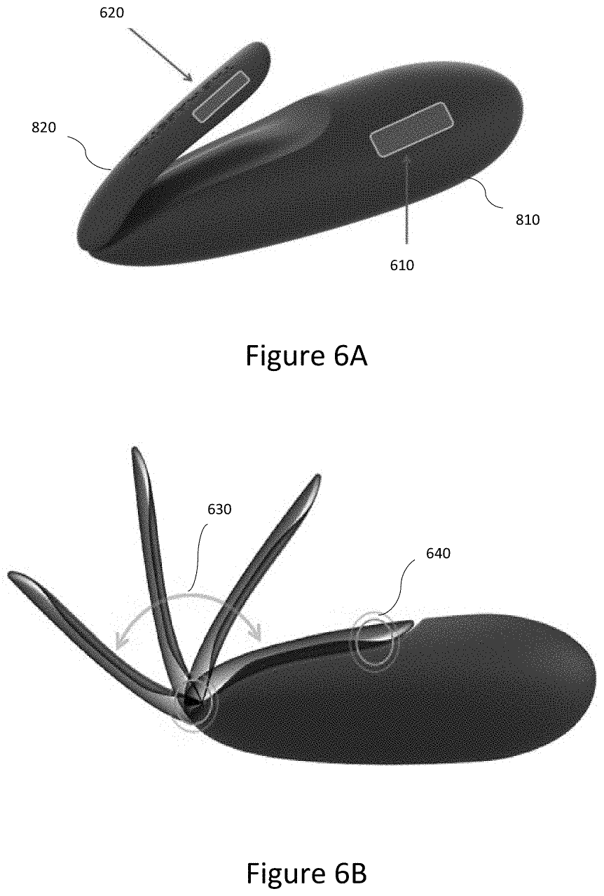

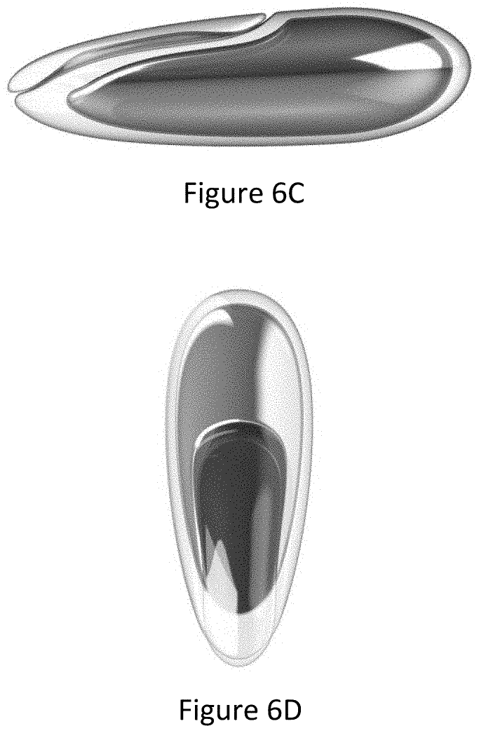

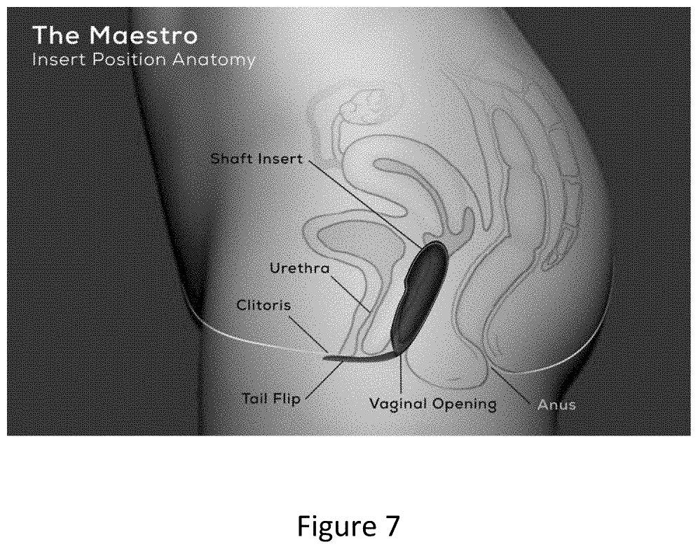

In one embodiment of the present invention, as shown in FIGS. 6A-D, the device itself 40 includes a shaft portion 810, a tail portion 820, and a hinge portion, allowing the tail portion 820 to rotate with respect to (toward and away from) the shaft portion 810. As shown in FIG. 7, this would allow the shaft portion to be place inside the user's vagina, and the tail portion rotated toward the shaft portion, until it comes to rest against the vulva (or clitoris portion thereof).

This design accomplishes several objectives. First, when the device is not in use (e.g., when charging, carried in one's purse, etc.), it can be collapsed into a small form factor, rendering the device more portable, compact, etc. Second, by allowing the tail portion to be rotated away from the shaft portion, beyond its normal angle of use, it is easier to insert the shaft portion into the user's vagina (e.g., similar to inserting a tampon). Third, the tail portion can then be rotated toward the shaft portion until it comes into contact with the vulva (or clitoris portion thereof), thereby securing the device in place. This is important because, unlike a tampon, which is held in place via friction, during arousal, the vagina walls will move away from one another, thereby reducing friction. Thus, the “clamping,” or sandwiching nature of the device, prevents the device from falling out or moving downward, during normal, everyday activities. This is important as the device is intended to be worn for extended periods of time. In fact, one of the key ideas and differentiation points from other commercially available pleasuring devices is that the device can be comfortably worn throughout the day with absolute personal discretion. The device should not be visible when worn in any type of clothing including skin-tight clothes such as skinny jeans or yoga leggings. The movable tail portion must be very thin and line the external vaginal wall in a way that is invisible on the outside.

Fourth, by rotating the tail portion so that is comes into contact with the vulva, the tail portion can also be used to stimulate the user's clitoris. This is accomplished by placing a motor 620 in the distal end of the tail portion 820. A second motor 610 can be placed in the shaft portion 810 to stimulate the vagina. Fifth, the tail portion also serves as a safety measure, preventing the device from straying too far into the vagina, making it impossible for the user to retrieve and posing a serious health risk. Sixth, by affixing the tail portion to the clitoris, the device retains it orientation within the vagina, which is necessary for the placement of motors within the shaft portion (e.g., ensuring that the motors are oriented correctly). Finally, because the tail portion is external to the user, it can be used to house components that are preferably external to the user. This may include, for example, certain sensors (e.g., to measure ambient temperature, location, etc.) and communication circuitry (e.g., the transceiver, it's antenna, etc.).

With reference to FIG. 6A, the device preferably includes two motors, a first one 610 in the shaft portion 810 and a second one 620 in the tail portion 820. The second one 620 may be located toward the distal end of the tail portion 820 so that it stimulates the clitoris. The first one 610 may also be located toward the distal end of the shaft portion 810 (preferably facing the tail portion) to provide vibration deep within the vagina. In one embodiment, the first motor 610 is larger than the second motor 620, and both should produce pulsating vibrations that create a pleasurable experience and can culminate into a cascade of sensual and enjoyable feelings and ultimately climax. Each motor may have a plurality (e.g., 3, 5, etc.) of intensity levels/vibration speed and a plurality (e.g., 3, 5, 10, etc.) of different vibration patterns. As discussed above, in a preferred embodiment, vibrations are to be exclusively remotely controlled, and it is implied that the wearer has no control over them other than ejecting the device. To ensure discretion, the device (or motors therein) should not be audible (or at least minimized so that others are not aware of its presence or operation). The vibrations should be in the vicinity of 10 dB to allow the user to wear it anywhere and at any time without drawing unwanted attention.

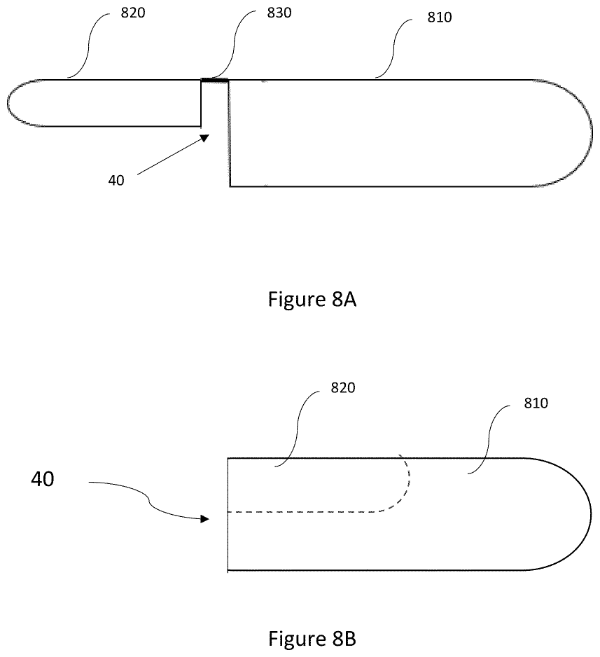

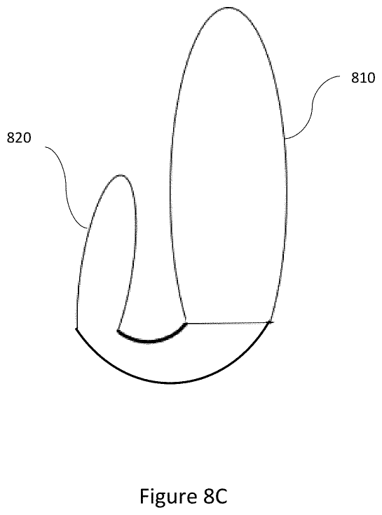

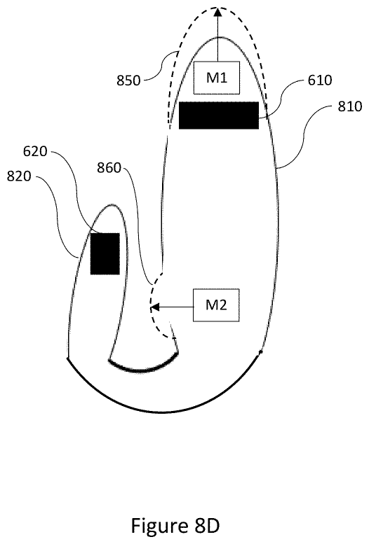

It should be appreciated that the present invention is not limited to the number and location of motors illustrated in FIG. 6A. For example, a device that includes additional motors or at least one motor located in a different position (e.g., toward a proximal end of the shaft portion, facing the tail portion, to stimulate the user's “G” spot) (see, e.g., FIG. 8D at M2), is within the spirit and scope of the present invention. Similarly, the present invention is not limited to the use of any particular motor. For example, an eccentric rotating mass vibration motor (ERM) or a linear resonant actuator (LRA) may be used to produce vibrations. Other motors generally known to those skilled in the art may also be used. For example, a motor may be used to make the shaft portion longer and shorter (see, e.g., FIG. 8D at M1) to simulate intercourse. A motor could also be used to make the shaft (or a portion thereof) wider and narrower (e.g., toward a proximal end of the shaft portion, facing the tail portion) (see, e.g., FIG. 8D at M2) to stimulate the user's “G” spot. The foregoing could be accomplished by using at least one motor to move at least one rod (with a smooth endpoint) outward, thereby expanding the pliable housing (e.g., silicone) of the device 40 (e.g., at its end, side, etc.). Returning the rod to its initial, starting location would return the housing to its original shape and size.

It should further be appreciated that a hinge-less device is also within the spirit and scope of the present invention. See, e.g., FIG. 8C. In this embodiment, the molded nature of the device, which can be pulled apart for insertion, will “spring” back (or try to spring back) to the position illustrated, thereby creating the foregoing “clamping” effect for securing the device in place.

However, in embodiments involving a hinge, the device can be constructed in a number of ways. For example, as shown in FIGS. 8A and B, the material used to construct (or house) the tail portion 820 and the shaft portion 810 can also be used to connect the same (i.e., at 830). For example, medical grade silicon could be used to construct (or cover) the tail portion 820, the shaft portion 810, and the hinge portion 830. A biasing device (e.g., metal, plastic, etc.) (not shown) could be embedded within the hinge portion 830, biasing the device in the position shown in FIG. 8B. It is this biasing that helps secure the device during use. In an alternate embodiment, the same biasing device could be used to bias the device in the position shown in FIG. 8C.

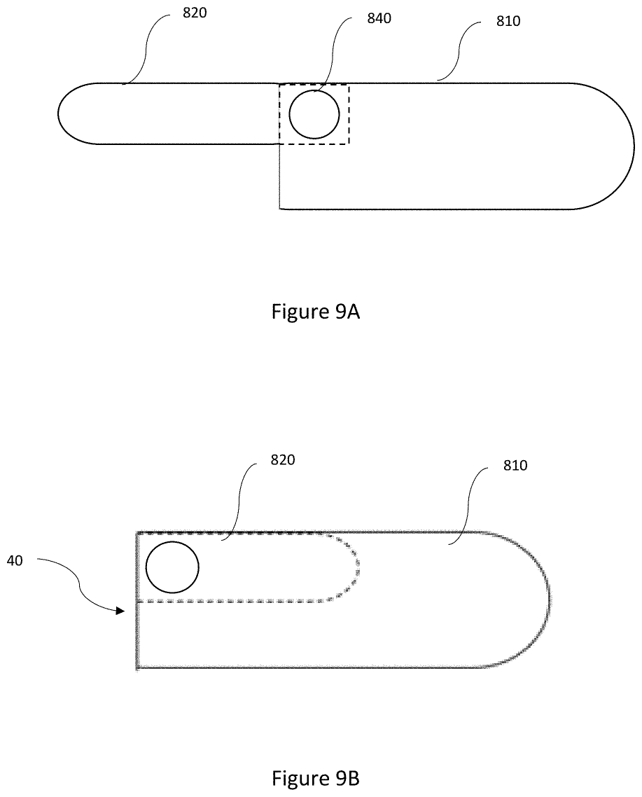

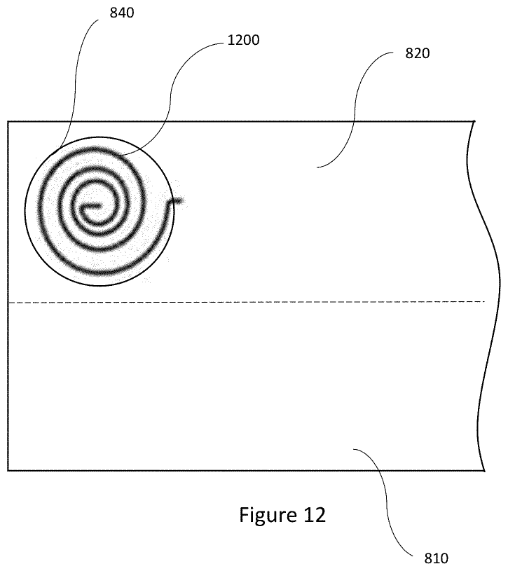

In yet another embodiment, shown in FIGS. 9A and B, the hinge portion includes a pin 840 (or the like) allowing the tail portion 820 to rotate with respect to the shaft portion 810. As shown in FIG. 12, the hinge portion may further include a biasing device (in this case, a “spring”), biasing the device in the position shown in FIG. 9B.

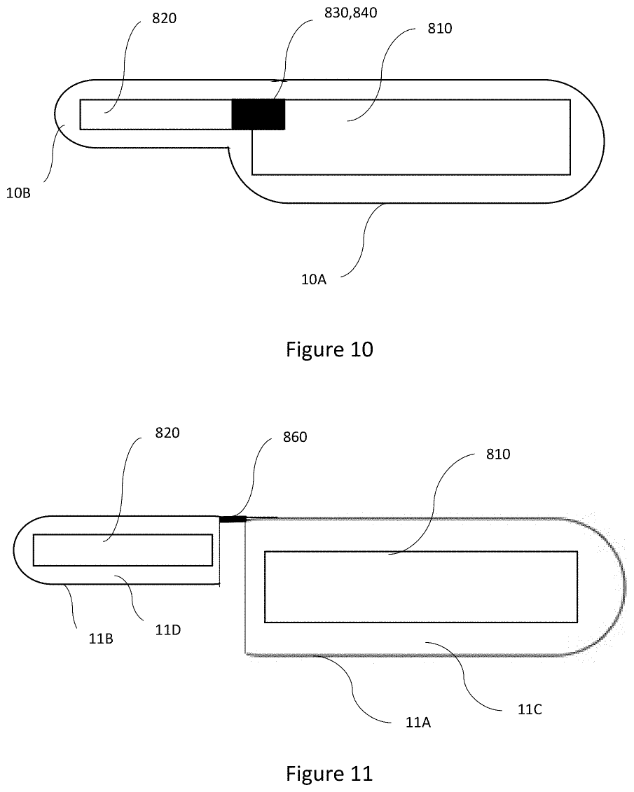

In either embodiment, to ensure cleanliness, prevent bacteria growth, etc., the tail portion 820, the shaft portion 810, and/or the hinge portion 830 may further be encapsulated in a soft, smooth, preferably pliable material (e.g., silicon). As shown in FIG. 10, this may be accomplished by encapsulating the entire device in a material 10A, which may either be solid or have an inner (e.g., liquid) material 10B (e.g., silicon, saline, etc.), to render the device more pliable. Alternatively, as shown in FIG. 11, this may be accomplished by encapsulating individual portions (see, e.g., 11A, 11B), which again, may be either solid or have an inner material (11C, 11D).

In a preferred embodiment, the housing is constructed using the highest-grade premium silicone, e.g., 100% medical grade silicone used in building medical prosthetics. It should have a supple feel, be body-friendly and odorless. Furthermore, the housing should be such that the device meets IPX8 waterproof standards, thus eliminating any possibility of electrical shock while worn or malfunction after washing/rinsing. The housing material (e.g., silicon) should require minimal care and cleaning that wouldn't involve any sort of antibacterial sanitizing, and a simple water rinse should suffice to make the device safe for reuse. With that being said, it should be appreciated that the present invention is not limited to any particular housing, and other housings generally known to those skilled in the art (e.g., plastic, rubber, etc.) are within the spirit and scope of the present invention.

In one embodiment, the device's electrical and mechanical components are not reachable from the surface. In a preferred embodiment, the device should not have any buttons as it is only meant to be controlled remotely (e.g., no power on/off button, etc.). When observed, the device should appear as a smooth and seamless unit, with a single parting line occupying the bottom half and mimicking the shape of device's outline.

In one embodiment of the present invention, the tail portion may also, or alternatively include a securing means, to prevent (or reduce the likelihood) of rotation during use. In other words, after the shaft portion has been inserted into the user's vagina, and the tail portion has been rotated to rest again the vulva (e.g., clitoris, clitoris hood, etc.), a securing means may be used to ensure that the tail portion does not move (e.g., toward and/or away from the shaft portion) during use.

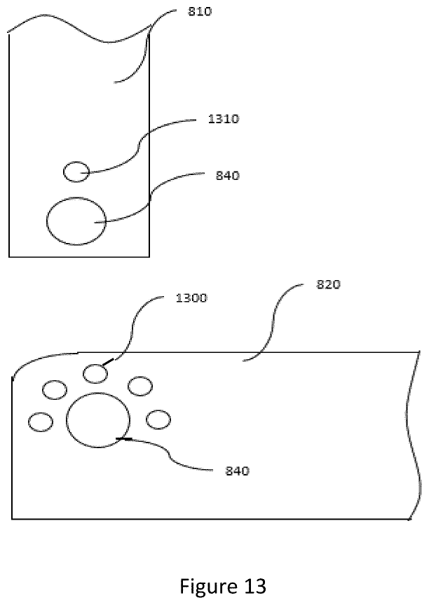

For example, as shown in FIG. 13, the shaft portion 820 may include a plurality of openings (or apertures) 1300 and the tail portion 810 may include a pin 1310. Once the tail portion 810 has been rotated to a particular position (e.g., a particular angle with respect to the shaft portion 820), the pin 1310 could be inserted into a corresponding hole 1300, similar to a belt for pants, where a prong is placed into a corresponding notch in the belt. The pin could subsequently be removed from the aperture, e.g., by pressing the pin, which may be spring loaded, similar to a retractable pen.

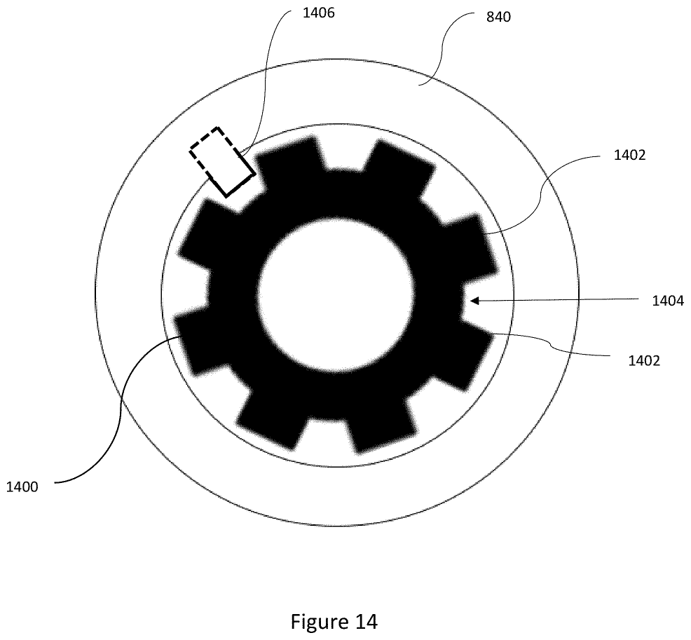

In another embodiment, as shown in FIG. 14, the tail portion may include a pin 1406 (e.g., a spring-loaded pin, a flexible pin, etc.) and the shaft portion may include a cog 1400 having a plurality of teeth 1402, defining a plurality of spaces 1404 therebetween. By rotating the tail portion with respect to the shaft portion, the pin 1406 will move (or click) from space to space (e.g., like a ratchet). While the tail portion can be manually rotated, the force required to do so should be enough so that the device is secure during normal, everyday use. It should be appreciated that the designs illustrated in FIGS. 12-14 are merely exemplary and are not limitations of the present invention. Thus, a vibrating apparatus that includes a different biasing device and/or securing device (or the lack thereof) is within the spirit and scope of the present invention.

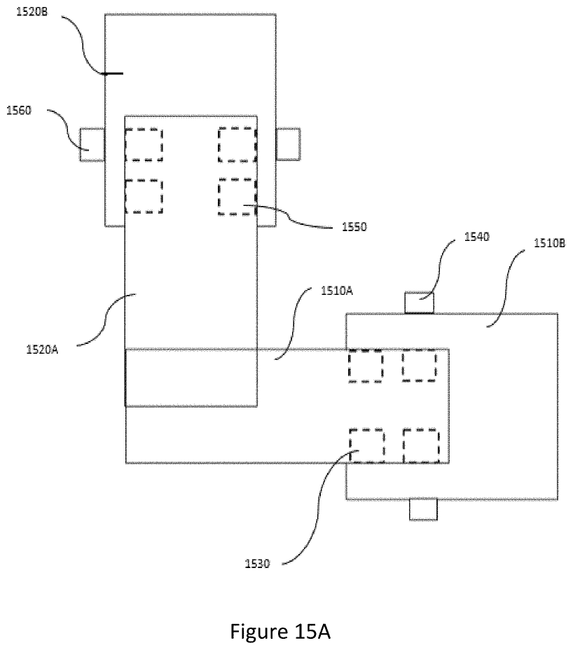

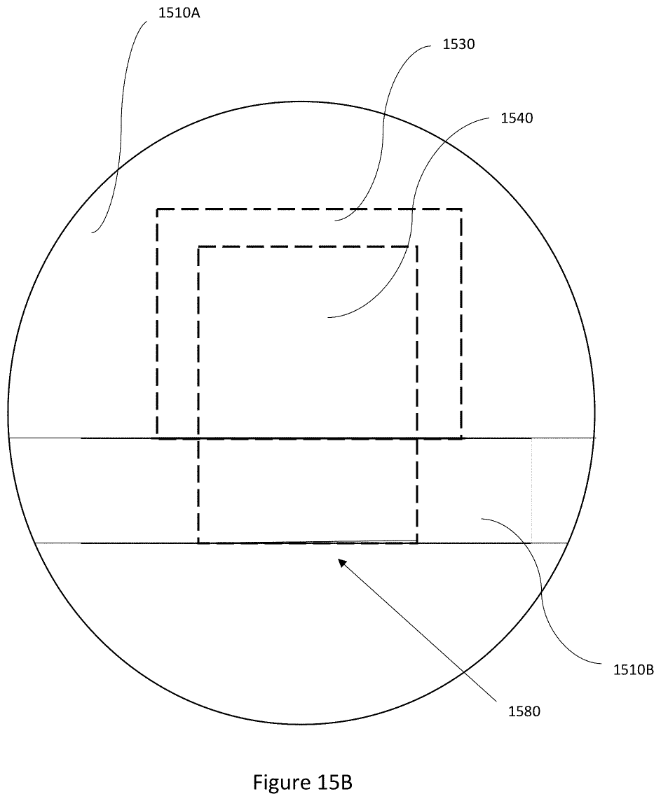

Because people, including vaginas and vulvas, come in different shapes and sizes, the device may be adjustable for a particular user. For example, as shown in FIGS. 15A and B, the tail portion may include a plurality of sleeves, i.e., an inner sleeve 1520A and an outer sleeve 1520B, allowing the tail to be telescopically adjusted to fit the user's body type. At least one pin 1560 (e.g., in the outer sleeve) and a plurality of openings (or apertures) 1550 (e.g., in the inner sleeve) may be used to secure the sleeves once a desired length is achieved. Similarly, the shaft portion may include a plurality of sleeves, i.e., an inner sleeve 1510A and an outer sleeve 1510B, allowing the shaft to be telescopically adjusted to fit the user's body type. At least one pin 1540 (e.g., in the outer sleeve) and a plurality of openings (or apertures) 1530 (e.g., in the inner sleeve) may be used to secure the sleeves one a desired length is achieved. This may be accomplished, for example, by pressing (e.g., clicking) the pin (e.g., 1540) inward, into an aperture (e.g., 1530), until it is flush with an outer surface of the outer sleeve (e.g., 1580). In one embodiment, the pin may be pressed again to move it outward, away from the aperture (e.g., like a clickable pen).

Again, it should be appreciated that the present invention is not limited to design shown in FIGS. 15A and B, and other designs (e.g., threaded sleeves, which can be rotated to adjust length, etc.), including devices that are fixed, and cannot be adjusted (e.g., one size fits all), are within the spirit and scope of the present invention. As discussed above, a motor may also be used to control the length and/or width of the shaft portion (or portion thereof), thereby allowing the operator to stimulate the vagina by making the shaft portion longer, shorter, wider, and/or narrower. See FIG. 8D.

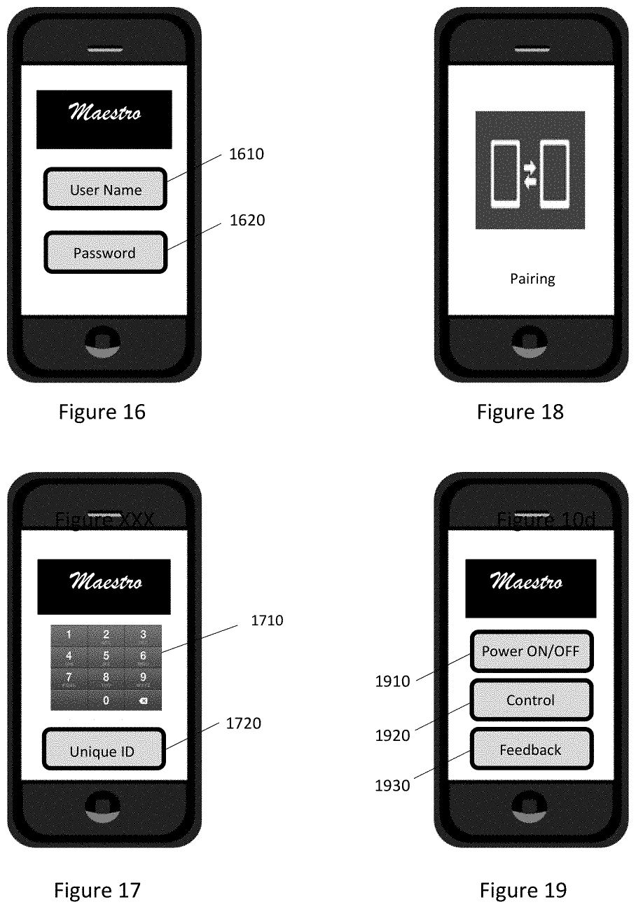

As discussed above, the device is preferably controlled by a remotely located phone, e.g., via an app that is downloaded from a host or other location on the Internet. The app may allow the phone to communicate directly with the device and/or communicate with the device indirectly (e.g., via the host). By way of example, this communication may involve logging into the app, pairing the phone with the device, controlling the device, and receiving/viewing feedback from the device. To this end, exemplary screen shots are provided in FIGS. 16 through 26. It should be appreciated that these are merely exemplary, and other, different screen shots are within the spirit and scope of the present invention.

As shown in FIG. 16, the user may log into the app or the host via a user name 1610 and a password 1620. Other authenticating data may also be required (e.g., two factor authentication, biometric data (e.g., facial recognition, fingerprint, etc.), etc. As shown in FIG. 17, to establish an exclusive relationship (e.g., pairing), the operator may need to enter a secure, unique number 1720 associated with the device (e.g., printed on the device or its packaging) via a keypad 1710. The app (or host) will then use this number to pair the phone with the device. See, e.g., FIG. 18. Once paired, the two devices may be “bonded,” where future pairing is unnecessary, and future connections are established automatically. Once the devices are paired (i.e., a communication path is established), the operator can control the device by selecting from a plurality of commands. For example, as shown in FIG. 19, the operator can turn the device on and off 1910, control the device 1920, and receive feedback from the device 1930.

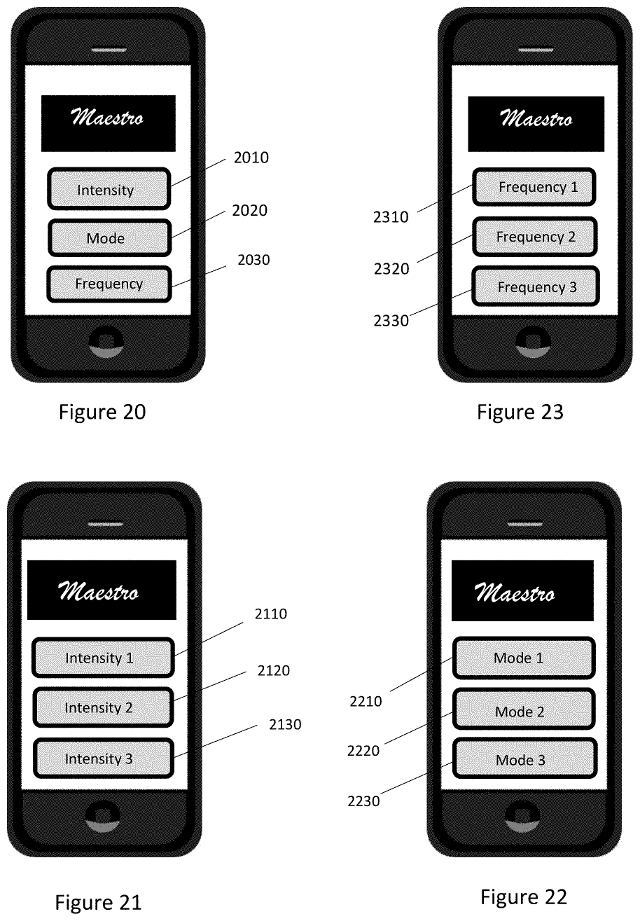

Once the device is turned on, the operator can control certain aspects of the device. For example, as shown in FIG. 20, the operator may control the intensity of the vibration (i.e., vibration amplitude) 2010 (see, e.g., FIG. 21, first intensity 2110, second intensity 2120, third intensity 2130, etc.). The operator may also control the mode of operation (e.g., different vibration patterns, such as pulsing, etc.) 2020 (see, e.g., FIG. 22, first mode 2210, second mode 2220, third mode 2230, etc.). The operator may further control the frequency of operation (i.e., vibration frequency) 2030 (see, e.g., FIG. 23, first frequency 2310, second frequency 2320, third frequency 2330, etc.). It should be appreciated that other controls are within the spirit and scope of the present invention. For example, the operator may control (on, off, mode, intensity, frequency, etc.) the first motor (in the shaft) separately from the second motor (in the tail), or other motors that are present (e.g., a motor to adjust length, width, etc.).

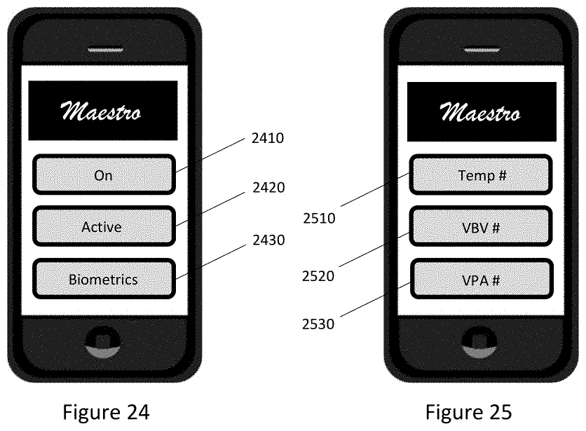

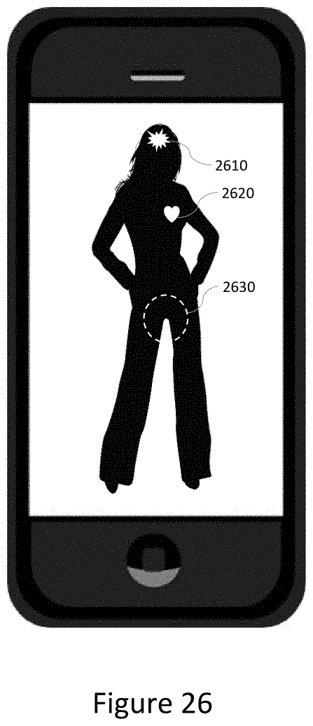

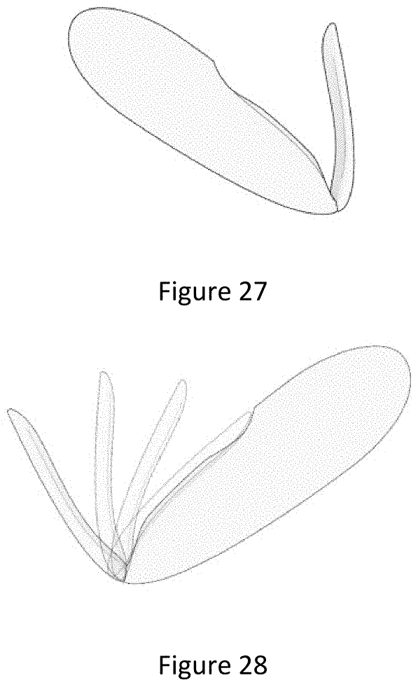

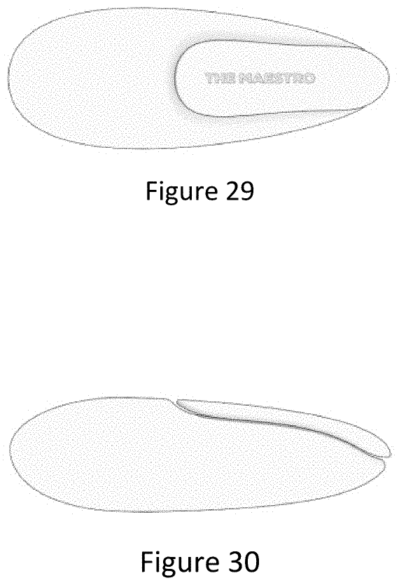

The operator can also receive feedback from the device. For example, as shown in FIG. 24, the user may be presented with operational information concerning the device (e.g., whether the device is on 2140, active 2420 (e.g., inserted, being worn, etc.), etc.). The operator may also receive biometric data 2430 concerning the user. For example, as shown in FIG. 25, this may include raw biometric data (e.g., the user's temperature 2510, VBV 2520, VPA 2520, etc.). It may also, or alternatively, include processed biometric data. For example, as shown in FIG. 26, processed feedback may be provided to the user indicating that the user is excited or anxious 2610, has an increased heart rate or blood pressure 2620, or is aroused 2630. Obviously, this GUI may provide feedback using other images (e.g., an image of the device and how it is currently being operated), graphics, charts, text, sounds, and/or motion (e.g., vibration that simulates the vibration that is being provided to the user).

It should be appreciated that other screens, allowing further control, or providing further feedback, are within the spirit and scope of the present invention. For example, a map may be provided showing the user's location, charts may be used to show changes in certain metrics over time, etc.

Having thus described preferred embodiments of a remote-controlled vibrator apparatus, it should be apparent to those skilled in the art that certain advantages have been achieved. It should also be appreciated that various modifications, adaptations, and alternative embodiments thereof may be made within the scope and spirit of the present invention. The invention is solely defined by the following claims.

What is claimed is:

1. A remote-controlled vibrator apparatus, comprising:
a shaft portion configured for placement within a user's vagina;
a tail portion configured for placement against said user's vulva;
a hinge portion between said shaft portion and said tail portion, said hinge portion allowing at least a distal end of said tail portion to be rotated toward said user's vulva and said shaft portion once said shaft portion has been inserted into said user's vagina;
a plurality of electrical components, comprising:
a processor;
at least one motor that can be operated to generate vibrations;
at least one battery for powering at least said motor and said processor; and
at least one transceiver in communication with said processor, said transceiver being configured to communicate with a remote device, said communications including at least operational controls for said motor.

2. The apparatus of claim 1, wherein said at least one motor comprises first and second motors, wherein said first motor is located within said shaft portion, providing vibrations within said user's vagina, and said second motor is located within said tail portion, providing vibrations on said user's vulva.

3. The apparatus of claim 2, wherein said second motor is located toward said distal end of said tail portion, providing vibrations on a clitoris portion of said user's vulva.

4. The apparatus of claim 1, further comprising an antenna within said tail portion, said antenna being electrically connected to said transceiver.

5. The apparatus of claim 1, further comprising wireless charging circuitry in electrical communication with said battery, thereby allowing said battery to be charged wirelessly without requiring an external port.

6. The apparatus of claim 1, wherein said hinge portion is spring-loaded, biasing said tail portion toward said shaft portion.

7. The apparatus of claim 1, further comprising a securing means for preventing further rotation of said tail portion with respect to said shaft portion once said distal end of said tail portion has been positioned against said user's vulva.

8. The apparatus of claim 1, wherein a length of at least one of said shaft portion and said tail portion can be adjusted to be longer and shorter.

9. The apparatus of claim 1, further comprising at least one biometric sensor for measuring at least one vital sign of said user, wherein said processor is configured to communicate information concerning said at least one vital sign to said remote device via said transceiver.

10. The apparatus of claim 1, further comprising at least one biometric sensor for measuring at least one of vaginal blood volume (VBV) and vaginal pulse amplitude (VPA), wherein said processor is configured to communicate information concerning at least one of said VBV and VPA to said remote device via said transceiver.

11. The apparatus of claim 1, further comprising at least one biometric sensor for measuring moisture, wherein said processor is configured to communicate information concerning the same to said remote device via said transceiver.

12. The apparatus of claim 1, further comprising at least one light emitting diode (LED) for indicating a charge level of said battery.

13. An apparatus for sexually stimulating a user, comprising:
a first portion configured for placement inside a user's vagina;
a second portion configured for placement on an outside of said user;
a hinge portion between said first and second portions, said hinge portion allowing said second portion to be moved toward said first portion;
a plurality of electrical components, comprising:
a processor;
at least one motor that can be operated to generate vibrations;
at least one battery for powering at least said motor and said processor; and
at least one transceiver in communication with said processor, said transceiver being configured to communicate with a remote device, said communications including at least operational controls for said motor and feedback from said apparatus.

14. The apparatus of claim 13, wherein said at least one motor comprises first and second motors, wherein said first motor is located within said first portion, providing vibrations within said user's vagina, and said second motor is located within said second portion, providing vibrations on said user's clitoris.

15. The apparatus of claim 13, further comprising an antenna within said second portion, said antenna being electrically connected to said transceiver.

16. The apparatus of claim 13, further comprising at least one spring biasing said second portion, rotationally, toward said first portion.

17. The apparatus of claim 13, further comprising at least one pair of interlocking components for preventing rotation of said first portion with respect to said second portion.

18. The apparatus of claim 13, further comprising at least one pair of interlocking components for reducing an easy at which said first portion rotates with respect to said second portion.

19. The apparatus of claim 13, further comprising at least one biometric sensor, where said processor is configured to communicate information received via said biometric sensor to said remote device via said transceiver.

20. The apparatus of claim 19, wherein said biometric sensor is configured to sense at least one of temperature, pulse, blood pressure, vaginal blood volume, vaginal pulse amplitude, and moisture.
